(19) United States
(12) Patent Application Publication
(10) Pub. No.: US 2025/0270718 A1
(43) Pub. Date: Aug. 28, 2025

(54) METHOD FOR PRODUCING NIOBIUM-CONTAINING TITANIUM-RUTHENIUM COMPOSITE NANOPARTICLES, NIOBIUM-CONTAINING TITANIUM-RUTHENIUM COMPOSITE NANOPARTICLES, AND CHLORINE-GENERATING ELECTRODE COMPRISING SAME

(71) Applicants: SEOUL NATIONAL UNIVERSITY R&DB FOUNDATION, Seoul (KR); KOOKMIN UNIVERSITY INDUSTRY ACADEMY COOPERATION FOUNDATION, Seoul (KR)

(72) Inventors: Jin Young KIM, Seoul (KR); Chan Woo LEE, Seoul (KR); Hyun Woo LIM, Gwangju (KR); Jae Hyun PARK, Seoul (KR)

(21) Appl. No.: 18/282,805

(22) PCT Filed: Feb. 8, 2022
(86) PCT No.: PCT/KR2022/001877

§ 371 Date: Feb. 26, 2024

(30) Foreign Application Priority Data
Mar. 25, 2021 (KR) 10-2021-0038832

(51) Int. Cl. C25B 11/093; C25B 1/26; C25B 11/037

(52) U.S. Cl. CPC C25B 11/093; C25B 1/26; C25B 11/037

(57) ABSTRACT

The present disclosure relates to a method for easily preparing niobium-containing titanium-ruthenium composite nanoparticles with excellent stability and electrochemical properties, niobium-containing titanium-ruthenium composite nanoparticles with excellent stability and efficiency, and a chlorine evolution electrode comprising the same.

### CROSS-REFERENCE OF RELATED APPLICATIONS

This specification claims the benefit of the filing date of Korean Patent Application No. 10-2021-0038832 filed in the Korean Intellectual Property Office on Mar. 25, 2021, all contents of which are included in the present disclosure.

### TECHNICAL FIELD

The present disclosure relates to a method for preparing niobium-containing titanium-ruthenium composite nanoparticles, niobium-containing titanium-ruthenium composite nanoparticles, and a chlorine evolution electrode comprising the same.

### BACKGROUND ART

Recently, RuO₂ is known as one of the most common catalysts for chlorine evolution reaction (CER). However, ruthenium-based catalysts have excellent catalytic properties but have a problem in that they are very expensive. Therefore, dimensionally stable anodes (DSAs) composed of 70 mol % rutile structure TiO₂ and 30 mol % RuO₂, having minimally dropped performance while minimizing the use of RuO₂, are used as commercial catalyst electrodes.

The catalytic electrodes are insoluble electrodes, and are widely applied in the water treatment field due to the advantages of electrodes' semi-permanent lives and excellent durabilities since the electrodes do not dissolve during the electrochemical reaction. However, the DSAs have a disadvantage in that they have a structure with a small specific surface area and thus require a large use amount of catalyst. In addition, when the chlorine evolution reaction using DSAs is performed, there is a problem in that a phenomenon of dissolving RuO₂ in DSAs occurs.

Accordingly, there is a need for a technology capable of preparing a chlorine evolution electrode having price competitiveness while having excellent stability by solving the problem of dissolving RuO₂ in the chlorine evolution reaction.

### DISCLOSURE

### Technical Problem

The technical problem to be achieved by the present disclosure is to provide a method for easily preparing niobium-containing titanium-ruthenium composite nanoparticles with excellent stability and electrochemical properties, niobium-containing titanium-ruthenium composite nanoparticles with excellent stability and electrochemical properties, and a chlorine evolution electrode comprising the same.

However, the problems to be solved by the present disclosure are not limited to the above-mentioned problem, and other problems not mentioned will be clearly understood by those skilled in the art from the following description.

### Technical Solution

As an embodiment of the present disclosure, there is provided a method for preparing niobium-containing titanium-ruthenium composite nanoparticles, the method including the steps of: preparing niobium-doped titanium-based nanoparticles by performing hydrothermal reaction of a first mixture containing a niobium precursor and titanium-based nanoparticles; preparing niobium-containing titanium-ruthenium composite nanoparticles by performing hydrothermal reaction of a second mixture containing the niobium-doped titanium-based nanoparticles and a ruthenium precursor; and heat-treating the niobium-containing titanium-ruthenium composite nanoparticles.

Furthermore, as an embodiment of the present disclosure, there are provided niobium-containing titanium-ruthenium composite nanoparticles including: a core containing ruthenium-based nanoparticles; and a shell which is provided on the surface of the core and contains niobium-doped titanium-based nanoparticles.

Furthermore, as an embodiment of the present disclosure, there is provided a chlorine evolution electrode including the niobium-containing titanium-ruthenium composite nanoparticles.

### Advantageous Effects

According to the embodiment of the present disclosure, the method for producing niobium-containing titanium-ruthenium composite nanoparticles can easily prepare niobium-containing titanium-ruthenium composite nanoparticles having excellent stability and electrochemical properties.

Furthermore, according to the embodiment of the present disclosure, the niobium-containing titanium-ruthenium composite nanoparticles can have excellent stability and excellent electrochemical properties.

Furthermore, according to the embodiment of the present disclosure, the chlorine evolution electrode can have excellent stability and chlorine evolution efficiency.

However, the effects of the present disclosure are not limited to the above-described effects, and may be variously extended within a range that does not deviate from the spirit and scope of the present disclosure.

### BRIEF DESCRIPTION OF DRAWINGS

FIG. 1 is a view showing elemental mapping images of niobium-containing titanium dioxide-ruthenium dioxide composite nanoparticles prepared in Example 1 through HAADF-STEM EDS analysis using Cs-corrected TEM.

FIG. 2 is a view showing line scan profiles of the niobium-containing titanium-ruthenium composite nanoparticles prepared in Example 1 of the present disclosure.

FIG. 3 is a view showing XRD patterns of composite nanoparticles prepared in Example 1, Comparative Example 3, Comparative Example 5, Comparative Example 6, and Comparative Example 7 of the present disclosure.

FIG. 4 is a view showing Raman spectra of composite nanoparticles prepared in Example 1, Comparative Example 2, and Comparative Example 3 of the present disclosure.

FIG. 5 is a view showing Mott-Schottky measurement results of the composite nanoparticles prepared in Example 1 and Comparative Example 3 of the present disclosure.

FIGS. 6A to 6D are a view of observing the shape of the composite nanoparticles prepared in Comparative Example 2.

FIGS. 7A to 7D are a view showing results of evaluating the electrochemical properties of the composite nanoparticles prepared in Example 1 of the present disclosure.

FIG. 8 is a view showing potentials over time recorded during a chronopotentiometric measurement experiment at a current density of 10 mA cm⁻² of the composite nanoparticles prepared in Example 1 of the present disclosure.

FIGS. 9A to 9D are a view showing CV scan results of the composite nanoparticles prepared in Example 1 of the present disclosure, glassy carbon, and DSAs.

FIG. 10 shows a view showing ratios of Ru/Ti on the surface of the composite nanoparticles before performing CV and after performing 50 CVs for the composite nanoparticles prepared in Example 1, Comparative Example 2, and Comparative Example 3 of the present disclosure.

FIGS. 11A to 11C are a view showing XPS spectra of O 1s before performing CV and after performing 50 CVs for the composite nanoparticles prepared in Example 1, Comparative Example 2, and Comparative Example 3 of the present disclosure.

FIGS. 12A to 12C are a view showing elemental mapping images of the composite nanoparticles prepared in Comparative Example 3.

FIGS. 13A to 13C are a view showing transmission electron microscope (TEM) images according to performing a CV cycle of the composite nanoparticles prepared in Comparative Example 3.

FIGS. 14A to 14D are a view showing results of observing the shape of the composite nanoparticles prepared in Comparative Example 2 according to performing a CV cycle.

FIGS. 15A and 15B are a view showing evaluation of the electrochemical properties of the composite nanoparticles prepared in Comparative Example 1 and the composite nanoparticles prepared in Comparative Example 2.

FIGS. 16A and 16B are a view showing results of evaluating the electrochemical properties of the composite nanoparticles prepared in Example 2 of the present disclosure.

FIG. 17 is a view comparing electrochemical property evaluation results of composite nanoparticles prepared in Example 1 and Comparative Example 8 of the present disclosure.

### BEST MODE

Throughout this specification, when a part is said to “include” a certain component, it means that it may further include other components without excluding other components unless specifically stated otherwise.

Throughout this specification, when a member is said to be located “on” other member, this includes not only a case where a member is in contact with other member, but also a case where another member exists between the two members.

In this specification, the terms “step to do ˜” and “step of ˜” do not mean “step for ˜”.

Hereinafter, specific details for the practice of the present disclosure will be described in detail with reference to the accompanying drawings.

An embodiment of the present disclosure provides a method for preparing niobium-containing titanium-ruthenium composite nanoparticles, the method including the steps of: preparing niobium-doped titanium-based nanoparticles by performing hydrothermal reaction of a first mixture containing a niobium precursor and titanium-based nanoparticles; preparing niobium-containing titanium-ruthenium composite nanoparticles by performing hydrothermal reaction of a second mixture containing the niobium-doped titanium-based nanoparticles and a ruthenium precursor; and heat-treating the niobium-containing titanium-ruthenium composite nanoparticles.

The method for preparing niobium-containing titanium-ruthenium composite nanoparticles according to an embodiment of the present disclosure can easily prepare niobium-containing titanium-ruthenium composite nanoparticles having excellent stability and electrochemical properties. Specifically, niobium is doped on titanium-based nanoparticles so that the niobium-containing titanium-ruthenium composite nanoparticles can be heat-treated at a lower temperature, and it is possible to effectively suppress the dissolution of ruthenium-based nanoparticles when the prepared niobium-containing titanium-ruthenium composite nanoparticles are used as a chlorine evolution electrode. In addition, niobium is doped on the titanium-based nanoparticles so that the electronic conductivity of the niobium-containing titanium-ruthenium composite nanoparticles can be improved, and the hydroxylation of titanium dioxide can be effectively suppressed, thereby maintaining more excellent electrochemical properties for a long period of time.

According to an embodiment of the present disclosure, a first mixture may be prepared by mixing a niobium precursor and titanium-based nanoparticles. Specifically, the first mixture may be prepared by adding the niobium precursor and the titanium-based nanoparticles to deionized water and mixing them.

According to an embodiment of the present disclosure, the titanium-based nanoparticles may include titanium dioxide (TiO₂) nanoparticles. The titanium dioxide nanoparticles are used as the titanium-based nanoparticles so that the electrochemical properties of the niobium-containing titanium-ruthenium composite nanoparticles can be further improved.

According to an embodiment of the present disclosure, the titanium-based nanoparticles may be in a powder form. The titanium-based nanoparticles in the powder form may be more easily mixed with the first mixture, and may have excellent compatibility with the niobium precursor. The titanium-based nanoparticles may have an average particle diameter of 10 nm or more and 100 nm or less. The titanium-based nanoparticles having an average particle diameter within the aforementioned range are used so that they may be more easily mixed with the first mixture and have excellent compatibility with the niobium precursor.

According to an embodiment of the present disclosure, the titanium-based nanoparticles may include an anatase crystal structure. Specifically, the titanium dioxide nanoparticles may include an anatase crystal structure. More specifically, the titanium dioxide nanoparticles may have an anatase crystal structure. The titanium-based nanoparticles including an anatase crystal structure are used so that electrochemical properties and durability of niobium-containing titanium-ruthenium composite nanoparticles to be prepared may be further improved.

According to an embodiment of the present disclosure, a material capable of doping niobium on the surface of the titanium-based nanoparticles may be used as the niobium precursor. Specifically, the niobium precursor may include a niobium halide. For example, the niobium halide may include at least one of NbF₅, NbCl₅, NbBr₅, and NbI₅. Specifically, the niobium halide may include NbCl₅ in terms of solubility and thermal stability. The niobium precursor containing a niobium halide is used so that the surface of the titanium-based nanoparticles may be more stably and effectively doped with niobium.

According to an embodiment of the present disclosure, the first mixture may contain a niobium precursor in an amount of 0.5 mol % or more and 7 mol % or less. Specifically, the niobium precursor may be contained in the first mixture in an amount of 0.7 mol % or more and 6.5 mol % or less, 1 mol % or more and 5 mol % or less, 1 mol % or more and 4.5 mol % or less, 1 mol % or more and 3.5 mol % or less, 1 mol % or more and 3 mol % or less, 1 mol % or more and 2.5 mol % or less, 1 mol % or more and 2 mol % or less, 0.5 mol % or more and 2 mol % or less, 0.5 mol % or more and 1.5 mol % or less, or 0.5 mol % or more and 1 mol % or less. When the content of the niobium precursor contained in the first mixture is within the above-described range, the surface of the titanium-based nanoparticles may be stably doped with niobium. In addition, the content of the niobium precursor contained in the first mixture is adjusted within the above-described range, thereby appropriately adjusting the niobium content in the niobium-containing titanium-ruthenium composite nanoparticles is appropriately adjusted as will be described later so that the stability and electrochemical properties of the niobium-containing titanium-ruthenium composite nanoparticles may be further improved. At this time, the content of the niobium precursor may be based on a total of 100 mol % of the niobium precursor and the titanium-based nanoparticles.

According to an embodiment of the present disclosure, the titanium-based nanoparticles may be contained in the first mixture in an amount of 93 mol % or more and 99.5 mol % or less. Specifically, the titanium-based nanoparticles may be contained in the first mixture in an amount of 93.5 mol % or more and 99.3 mol % or less, 95 mol % or more and 99 mol % or less, 95.5 mol % or more and 99 mol % or less, 96.5 mol % or more and 99 mol % % or less, 97 mol % or more and 99 mol % or less, 97.5 mol % or more and 99 mol % or less, 98 mol % or more and 99 mol % or less, 98 mol % or more and 99.5 mol % or less, 98.5 mol % or more and 99.5 mol % or less, or 99 mol % or more and 99.5 mol % or less. When the content of the titanium-based nanoparticles contained in the first mixture is within the above-described range, the electrochemical properties and durability of niobium-containing titanium-ruthenium composite nanoparticles to be prepared may be further improved. At this time, the content of the titanium-based nanoparticles may be based on a total of 100 mol % of the niobium precursor and the titanium-based nanoparticles.

According to an embodiment of the present disclosure, niobium-doped titanium-based nanoparticles may be prepared by performing a hydrothermal reaction (first hydrothermal reaction) of the first mixture. The niobium-doped titanium-based nanoparticles may be more easily prepared by a simple method of performing a hydrothermal reaction of the first mixture. In addition, a hydrothermal reaction of the first mixture is performed so that the cost required for the entire process of preparing the niobium-containing titanium-ruthenium composite nanoparticles may be effectively reduced. That is, niobium-containing titanium-ruthenium composite nanoparticles having excellent price competitiveness may be prepared through the method according to an embodiment of the present disclosure.

According to an embodiment of the present disclosure, the hydrothermal reaction of the first mixture may be performed at a temperature of 150° C. or higher and 200° C. or lower for a time of 5 hours or more and 8 hours or less. Specifically, the temperature at which the first hydrothermal reaction is performed may be 160° C. or higher and 190° C. or lower, 170° C. or higher and 180° C. or lower, 150° C. or higher and 180° C. or lower, or 160° C. or higher and 200° C. or lower. In addition, the time during which the first hydrothermal reaction is performed may be 6 hours or more and 7 hours or less, 5 hours or more and 7 hours or less, or 6 hours or more and 8 hours or less. The temperature and time at which the first hydrothermal reaction is performed are adjusted to the above-described range so that niobium may be more stably and efficiently doped on the surface of the titanium-based nanoparticles.

According to an embodiment of the present disclosure, the first hydrothermal reaction may heat the first mixture up to the above-described temperature range at a temperature raising rate of 5° C./min or more and 15° C./min or less, 7° C./min or more and 13° C./min or less, 5° C./min or more and 10° C./min or less, or 10° C./min or more and 15° C./min or less. When the temperature raising rate of the first mixture is within the above-described range, niobium may be more stably and efficiently doped on the surface of the titanium-based nanoparticles by preventing an abrupt thermal shock from being applied to the first mixture.

According to an embodiment of the present disclosure, a second mixture may be prepared by mixing the niobium-doped titanium-based nanoparticles and the ruthenium precursor. Specifically, the second mixture may be prepared by adding the niobium-doped titanium-based nanoparticles and the ruthenium precursor to deionized water and mixing them.

According to an embodiment of the present disclosure, the ruthenium precursor may include a ruthenium halide. For example, the ruthenium halide may include at least one of RuF₃, RuCl₃, RuBr₃, and RuI₃. Specifically, the ruthenium halide may include RuCl₃ in terms of solubility and thermal stability. The ruthenium-based nanoparticles may be effectively formed by using the ruthenium precursor including a ruthenium halide. Through this, niobium-containing titanium-ruthenium composite nanoparticles may be stably prepared. In addition, the ruthenium precursor may be a hydrate. The ruthenium precursor in the form of a hydrate is used so that the ruthenium precursor may be more easily dissolved in the second mixture, and compatibility with the niobium-doped titanium-based nanoparticles may be improved.

According to an embodiment of the present disclosure, the ruthenium precursor may be contained in the second mixture in an amount of 3 wt % or more and 10 wt % or less. Specifically, the ruthenium precursor may be contained in the second mixture in an amount of 4.5 wt % or more and 8.5 wt % or less, 5 wt % or more and 7 wt % or less, 3 wt % or more and 7.5 wt % or less, 4 wt % or more and 7 wt % or less, 5 wt % or more and 6 wt % or less, 5 wt % or more and 10 wt % or less, or 6 wt % or more and 8 wt % or less.

When the content of the ruthenium precursor contained in the second mixture is within the above-described range, niobium-containing titanium-ruthenium composite nanoparticles may be stably prepared through a hydrothermal reaction of the second mixture. In addition, the content of the ruthenium precursor contained in the second mixture is adjusted to the above-described range, and thus, as will be described later, niobium-containing titanium-ruthenium composite nanoparticles which minimize the content of the ruthenium-based nanoparticles and have excellent electrochemical properties at the same time may be prepared. At this time, the content of the ruthenium precursor may be based on a total of 100 wt % of the niobium-doped titanium-based nanoparticles and the ruthenium precursor.

According to an embodiment of the present disclosure, the niobium-doped titanium-based nanoparticles may be contained in the second mixture in an amount of 90 wt % or more and 97 wt % or less. Specifically, the niobium-doped titanium-based nanoparticles may be contained in the second mixture in an amount of 91.5 wt % or more and 95.5 wt % or less, 93 wt % or more and 95 wt % or less, 92.5 wt % or more and 97 wt % or less, 93 wt % or more and 96 wt % or less, 94 wt % or more and 95 wt % or less, 90 wt % or more and 95 wt % or less, or 92 wt % or more and 94 wt % or less. When the content of the niobium-doped titanium-based nanoparticles contained in the second mixture is within the above-described range, niobium-containing titanium-ruthenium composite nanoparticles which minimize the content of the ruthenium-based nanoparticles and have excellent electrochemical properties at the same time may be prepared. At this time, the content of the niobium-doped titanium-based nanoparticles may be based on a total of 100 wt % of the niobium-doped titanium-based nanoparticles and the ruthenium precursor.

According to an embodiment of the present disclosure, niobium-containing titanium-ruthenium composite nanoparticles may be prepared by performing a hydrothermal reaction (second hydrothermal reaction) of the second mixture. The niobium-containing titanium-ruthenium composite nanoparticles may be more easily prepared by a simple method of performing a hydrothermal reaction of the second mixture. In addition, a hydrothermal reaction of the second mixture is performed so that the cost required for the entire process of preparing the niobium-containing titanium-ruthenium composite nanoparticles may be effectively reduced. That is, niobium-containing titanium-ruthenium composite nanoparticles having excellent price competitiveness may be prepared through the method according to an embodiment of the present disclosure.

According to an embodiment of the present disclosure, the hydrothermal reaction (second hydrothermal reaction) of the second mixture may be performed at a temperature of 130° C. or higher and 180° C. or lower for a time of 8 hours or more and 15 hours or less. Specifically, the temperature at which the second hydrothermal reaction is performed may be 140° C. or higher and 170° C. or lower, 150° C. or higher and 160° C. or lower, 130° C. or higher and 160° C. or lower, 140° C. or higher and 150° C. or lower, 140° C. or higher and 180° C. or lower, or 150° C. or higher and 170° C. or lower. In addition, the time during which the second hydrothermal reaction is performed may be 9 hours or more and 13 hours or less, 10 hours or more and 12 hours or less, 8 hours or more and 11 hours or less, 10 hours or more and 15 hours or less, or 10 hours or more and 13 hours or less. The temperature and time at which the second hydrothermal reaction is performed are adjusted to the above-described range so that the niobium-containing titanium-ruthenium composite nanoparticles may be formed more stably and efficiently.

According to an embodiment of the present disclosure, the second hydrothermal reaction may heat the second mixture up to the above-described temperature range at a temperature raising rate of 5° C./min or more and 15° C./min or less, 7° C./min or more and 13° C./min or less, 5° C./min or more and 10° C./min or less, or 10° C./min or more and 15° C./min or less. When the temperature raising rate of the second mixture is within the above-described range, the niobium-containing titanium-ruthenium composite nanoparticles may be prepared more stably by preventing an abrupt thermal shock from being applied to the second mixture.

According to an embodiment of the present disclosure, the temperature at which the first hydrothermal reaction is performed may be higher than the temperature at which the second hydrothermal reaction is performed, and the time at which the first hydrothermal reaction is performed may be shorter than the time at which the second hydrothermal reaction is performed. Through this, it may be possible to improve the efficiency of the entire process of preparing niobium-containing titanium-ruthenium composite nanoparticles, and there may be a process advantage in that preparation cost and time can be effectively reduced.

According to an embodiment of the present disclosure, the heat treatment may be performed at a temperature of 150° C. or higher and 250° C. or lower. Specifically, the niobium-containing titanium-ruthenium composite nanoparticles may be heat-treated at a temperature of 165° C. or higher and 235° C. or lower, 180° C. or higher and 220° C. or lower, 190° C. or higher and 210° C. or lower, 150° C. or higher and 220° C. or lower, 170° C. or higher and 210° C. or lower, 180° C. or higher and 200° C. or lower, 180° C. or higher and 250° C. or lower, 190° C. or higher and 230° C. or lower, or 200° C. or higher and 220° C. or lower. The heat treatment temperature is adjusted to the above-described range so that the stability and electrochemical properties of the niobium-containing titanium-ruthenium composite nanoparticles may be effectively improved. Specifically, when the temperature at which the niobium-containing titanium-ruthenium composite nanoparticles are heat-treated is within the above-described range, niobium-doped titanium-based nanoparticles may be effectively formed on the surface of the ruthenium-based nanoparticles as will be described later. Through this, the electrochemical properties of the niobium-containing titanium-ruthenium composite nanoparticles may be improved, and the dissolution of the ruthenium-based nanoparticles in the niobium-containing titanium-ruthenium composite nanoparticles may be effectively suppressed when the niobium-containing titanium-ruthenium composite nanoparticles are used as a chlorine evolution electrode.

On the other hand, when the temperature at which the niobium-containing titanium-ruthenium composite nanoparticles are heat-treated is out of the above-described range, the niobium-doped titanium-based nanoparticles cannot be effectively formed on the surface of the ruthenium-based nanoparticles. In particular, when the temperature at which the niobium-containing titanium-ruthenium composite nanoparticles are heat-treated exceeds the above-described range, the ruthenium-based nanoparticles diffuse into the titanium-based nanoparticles, and thus a problem of deteriorating durability and electrochemical properties of niobium-containing titanium-ruthenium composite nanoparticles to be prepared may occur.

According to an embodiment of the present disclosure, the heat treatment step may be performed for 0.5 hours or more and 2 hours or less. Specifically, the heat treatment step may be performed for 1 hour or more and 2 hours or less. The time during which the heat treatment step is performed is adjusted to the above-described range so that the niobium-doped titanium-based nanoparticles may be effectively formed on the surface of the ruthenium-based nanoparticles.

According to an embodiment of the present disclosure, the heat treatment step may heat the niobium-containing titanium-ruthenium composite nanoparticles up to the above-described temperature range at a temperature raising rate of 5° C./min or more and 15° C./min or less, 7° C./min or more and 13° C./min or less, 5° C./min or more and 10° C./min or less, or 10° C./min or more and 15° C./min or less. When the temperature raising rate of the niobium-containing titanium-ruthenium composite nanoparticles is within the above-described range, the niobium-doped titanium-based nanoparticles may be stably and efficiently formed on the surface of the ruthenium-based nanoparticles by preventing an abrupt thermal shock from being applied to the niobium-containing titanium-ruthenium composite nanoparticles.

According to an embodiment of the present disclosure, the niobium-containing titanium-ruthenium composite nanoparticles may be niobium-containing titanium dioxide (TiO₂)-ruthenium dioxide (RuO₂) composite nanoparticles. As described above, niobium-containing titanium dioxide (TiO₂)-ruthenium dioxide (RuO₂) composite nanoparticles having excellent durability and electrochemical properties may be prepared more easily and at a lower cost through the preparation method according to an embodiment of the present disclosure.

According to an embodiment of the present disclosure, a chlorine evolution electrode including niobium-containing titanium-ruthenium composite nanoparticles may be formed through the above-described method. That is, an embodiment of the present disclosure may provide a method for preparing a chlorine evolution electrode including niobium-containing titanium-ruthenium composite nanoparticles.

An embodiment of the present disclosure provides niobium-containing titanium-ruthenium composite nanoparticles including: ruthenium-based nanoparticle; and niobium-doped titanium-based nanoparticles provided on the surface of the ruthenium-based nanoparticles.

Specifically, an embodiment of the present disclosure provides niobium-containing titanium-ruthenium composite nanoparticles including: a core containing ruthenium-based nanoparticles; and a shell which is provided on the surface of the core and contains niobium-doped titanium-based nanoparticles.

The niobium-containing titanium-ruthenium composite nanoparticles according to an embodiment of the present disclosure may be prepared through the above-described method for preparing niobium-containing titanium-ruthenium composite nanoparticles.

The niobium-containing titanium-ruthenium composite nanoparticles according to an embodiment of the present disclosure may have excellent stability and excellent electrochemical properties. Niobium-doped titanium-based nanoparticles are formed on the surface of the ruthenium-based nanoparticles, and thus composite nanoparticles with a core-shell structure, including a core containing the ruthenium-based nanoparticles and a shell containing the niobium-doped titanium-based nanoparticles, are formed so that the electrochemical properties of the niobium-containing titanium-ruthenium composite nanoparticles may be effectively improved. Specifically, when the niobium-containing titanium-ruthenium composite nanoparticles are used as an electrode, chlorine evolution efficiency may be excellent. In addition, the niobium-containing titanium-ruthenium composite nanoparticles may have excellent resistance to anodic corrosion. Specifically, since a niobium-doped titanium-based nanoparticle shell is formed on the ruthenium-based nanoparticle core, dissolution of the ruthenium-based nanoparticles when applied as a chlorine evolution electrode may be effectively suppressed. In addition, niobium is doped on the titanium-based nanoparticles so that the electronic conductivity of the niobium-containing titanium-ruthenium composite nanoparticles may be improved, and the hydroxylation of titanium dioxide is effectively suppressed so that more excellent electrochemical properties may be maintained for a long period of time.

According to an embodiment of the present disclosure, the core may further contain titanium. Specifically, the core may comprise the ruthenium-based nanoparticles and titanium particles. The titanium particles contained in the core may be derived from the niobium-doped titanium-based nanoparticles. In the process of performing a hydrothermal reaction (second hydrothermal reaction) of the above-described second mixture, titanium particles may be contained in the core. Titanium is contained in the ruthenium-based nanoparticle core so that the electrochemical properties of the niobium-containing titanium-ruthenium composite nanoparticles may be effectively improved.

According to an embodiment of the present disclosure, the shell may be a single layer, and the shell may have a thickness of 3 Å or more and 10 Å or less. Through previously known data, it can be confirmed that the shell corresponds to a single layer and the thickness of the shell falls corresponds to the above-described range. Specifically, in the conventionally known titanium dioxide structure, the distance between titanium atoms and the thickness of the shell match so that it can be confirmed that the thickness of the shell corresponds to a single layer. The niobium-containing titanium-ruthenium composite nanoparticles provided with a single-layer niobium-doped titanium-based nanoparticle shell having a thickness in the above-described range may realize excellent resistance to anodic corrosion and excellent electrochemical properties.

According to an embodiment of the present disclosure, the niobium-containing titanium-ruthenium composite nanoparticles may have an average particle size of 1 nm or more and 2.5 nm or less. The niobium-containing titanium-ruthenium composite nanoparticles having an average particle size of the above-described range may realize excellent resistance to anodic corrosion and excellent electrochemical properties. The average particle size of the niobium-containing titanium-ruthenium composite nanoparticles may be calculated from a TEM image of the niobium-containing titanium-ruthenium composite nanoparticles. Specifically, the average particle size may be confirmed using line-scan data of the TEM image.

According to an embodiment of the present disclosure, the titanium-based nanoparticles may be titanium dioxide (TiO₂) nanoparticles, and the ruthenium-based nanoparticles may be ruthenium dioxide (RuO₂) nanoparticles. That is, the niobium-containing titanium-ruthenium composite nanoparticles may be niobium-containing titanium dioxide (TiO₂)-ruthenium dioxide (RuO₂) composite nanoparticles. As described above, the niobium-containing titanium dioxide (TiO₂)-ruthenium dioxide (RuO₂) composite nanoparticles may have excellent resistance to anodic corrosion and electrochemical properties. In particular, in the case of using a chlorine evolution electrode, ruthenium dioxide nanoparticles are effectively prevented from being dissolved so that the electrode may have excellent durability and stability, and efficiency of the chlorine evolution reaction may be excellent.

According to an embodiment of the present disclosure, the ruthenium-based nanoparticles may be contained in an amount of 2 at % or less. Specifically, the ruthenium dioxide nanoparticles may be contained in the niobium-containing titanium-ruthenium composite nanoparticles in an amount of 2 at % or less, 1.8 at % or less, 1.5 at % or less, 1.3 at % or less, or 1.1 at % or less. In addition, the ruthenium dioxide nanoparticles may be contained in an amount of 0.8 at % or more, or 1 at % or more. When the content of the ruthenium-based nanoparticles contained in the niobium-containing titanium-ruthenium composite nanoparticles is within the above-described range, there is an advantage in that price efficiency is excellent since expensive ruthenium element is contained in a very small amount. In addition, even when the content of the ruthenium-based nanoparticles is within the above-described range, the niobium-containing titanium-ruthenium composite nanoparticles may effectively perform a chlorine evolution reaction. At this time, the content of the ruthenium-based nanoparticles may be based on a total of 100 at % of ruthenium-based nanoparticles, titanium-based nanoparticles, and niobium.

In addition, the content of the ruthenium atoms contained in the niobium-containing titanium-ruthenium composite nanoparticles may be 2 at % or less. Specifically, the content of the ruthenium atoms may be 2 at % or less, 1.8 at % or less, 1.5 at % or less, 1.3 at % or less, or 1.1 at % or less, and may be 0.8 at % or more, or 1 at % or more. At this time, the content of the ruthenium atoms may be based on a total of 100 at % of ruthenium atoms, titanium atoms, and niobium atoms.

According to an embodiment of the present disclosure, the content of niobium may be 1.5 at % or more and 5 at % or less. Specifically, the content of niobium contained in the niobium-containing titanium-ruthenium composite nanoparticles may be 1.7 at % or more and 4.5 at % or less, 1.9 at % or more and 4 at % or less, 2 at % or more and 3 at % or less, 1.5 at % or more and 3.5 at % or less, or 1.7 at % or more and 2.5 at % or less. When the niobium content is within the above-described range, resistance of the niobium-containing titanium-ruthenium composite nanoparticles to anodic corrosion may be effectively improved. The niobium content may be based on a total of 100 at % of ruthenium-based nanoparticles, titanium-based nanoparticles, and niobium. In addition, the content of the niobium atoms may be based on a total of 100 at % of ruthenium atoms, titanium atoms, and niobium atoms.

According to an embodiment of the present disclosure, the titanium-based nanoparticles may have an anatase crystal structure, and the ruthenium-based nanoparticles may have a rutile crystal structure. Specifically, in the niobium-containing titanium dioxide (TiO₂)-ruthenium dioxide (RuO₂) composite nanoparticles, titanium dioxide may have an anatase crystal structure, and ruthenium dioxide may have a rutile crystal structure. More specifically, titanium dioxide may have an anatase crystal structure. The niobium-containing titanium-ruthenium composite nanoparticles including titanium-based nanoparticles having an anatase crystal structure and ruthenium-based nanoparticles having a rutile crystal structure may have excellent electrochemical properties.

According to an embodiment of the present disclosure, in the niobium-containing titanium-ruthenium composite nanoparticles, a Raman peak may be shifted upward compared to that of ruthenium dioxide, and the upward shift may be shifted upward at a wave number of 720 cm⁻¹ or more and 740 cm⁻¹ or less. Specifically, in contrast to pure ruthenium dioxide having a Raman scattering peak of 716 cm¹, the niobium-containing titanium-ruthenium composite nanoparticles may have a Raman scattering peak of ruthenium dioxide shifted upward to 730 cm¹ as titanium is doped with niobium.

According to an embodiment of the present disclosure, the niobium-containing titanium-ruthenium composite nanoparticles may have a faradaic efficiency of 90% or more at a current density of 5 mA cm⁻² or more and 50 mA cm⁻² or less. Specifically, the niobium-containing titanium-ruthenium composite nanoparticles may have a faraday efficiency of 90% or more at a current density of 10 mA cm⁻² or more and 50 mA cm⁻² or less. The niobium-containing titanium-ruthenium composite nanoparticles realizing the faradaic efficiency in the above-described range may exhibit excellent efficiency for chlorine evolution reaction when applied to a chlorine evolution electrode.

According to an embodiment of the present disclosure, the niobium-containing titanium-ruthenium composite nanoparticles may have an overpotential value of 15 mV or more and 60 mV or less under conditions of 0.5 M or more and 5.5 M or less NaCl, pH 2 or more and 6 or less, and 10 mV cm⁻². Specifically, the niobium-containing titanium-ruthenium composite nanoparticles may have an overpotential value of 20 mV or more and 50 mV or less under conditions of 0.6 M or more and 5.0 M or less NaCl, pH 2 or more and 6 or less, and 10 mV cm⁻². The niobium-containing titanium-ruthenium composite nanoparticles having an overpotential value in the above-described range under the above-described conditions may exhibit excellent efficiency for the chlorine evolution reaction when applied to a chlorine evolution electrode.

According to an embodiment of the present disclosure, the niobium-containing titanium-ruthenium composite nanoparticles may have a peak intensity retention rate of M-O bonds of 99% or more and 99.9% or less and a peak intensity increase rate of M-OH bonds of 0.2% or more and 0.3% or less when comparing before performing CV with after performing CV 50 times. That is, the niobium-containing titanium-ruthenium composite nanoparticles may exhibit electrochemically very stable physical properties.

An embodiment of the present disclosure provides a chlorine evolution electrode including the niobium-containing titanium-ruthenium composite nanoparticles.

The chlorine evolution electrode according to an embodiment of the present disclosure may have excellent stability and chlorine evolution efficiency. As described above, the niobium-containing titanium-ruthenium composite nanoparticles have excellent electrochemical properties and durability so that the chlorine evolution electrode can realize excellent efficiency for the chlorine evolution reaction for a long period of time. In addition, since the chlorine evolution electrode contains a very small amount of expensive ruthenium, price competitiveness may be excellent.

### MODE FOR INVENTION

Hereinafter, Examples will be described in detail to explain the present disclosure in detail. However, embodiments according to the present disclosure can be modified in various different forms, and the scope of the present disclosure is not construed as being limited to Examples described below. The embodiments in this specification are provided to more completely explain the present disclosure to those skilled in the art.

### Example 1

P25 (Aldrich, purity 99.5%) was prepared as titanium-based nanoparticles (TiO₂), NbCl₅ (Aldrich, purity 99%) was prepared as a niobium precursor, RuCl₃·3H₂O (Aldrich, purity 99.98%) was prepared as a ruthenium precursor, and deionized water prepared using a water purifier (Human Corporation, Human RO 180) was prepared.

P25 was added to deionized water and mixed for 15 minutes, and NbCl₅ was added to deionized water mixed with P25 and mixed for an additional 15 minutes to prepare a first mixture. At this time, in the first mixture, the content of P25 was 99 mol % and the content of NbCl₅ was 1 mol % based on a total of 100 mol % of P25 and NbCl₅. Thereafter, the first mixture was moved to a Teflon container, put in an autocave, and subjected to a hydrothermal reaction in a furnace for hydrothermal synthesis (CBF-S010 M, Thermo-tech Co., Ltd.). At this time, the first mixture was heated at a temperature raising rate of 10° C./min to perform the hydrothermal reaction at a temperature of 180° C. for 6 hours. Thereafter, the solution in which the hydrothermal reaction was completed was cooled to room temperature, and washed with distilled water 5 times at 5,000 rpm using a centrifuge. The washed solution was dried in a vacuum oven maintained at 90° C. for 24 hours to obtain niobium-doped titanium-based nanoparticles (TiO₂).

The prepared niobium-doped titanium-based nanoparticles were added to deionized water and mixed for 15 minutes, and RuCl₃·3H₂O was added to deionized water in which the niobium-doped titanium-based nanoparticles were mixed and mixed for additional 15 minutes to prepare a second mixture. At this time, in the second mixture, the content of the niobium-doped titanium-based nanoparticles was 94 wt % and the content of RuCl₃·3H₂O was 6 wt % based on a total of 100 wt % of the niobium-doped titanium-based nanoparticles and RuCl₃·3H₂O. Thereafter, the second mixture was moved to a Teflon container, put in an autocave, and subjected to a hydrothermal reaction in a furnace for hydrothermal synthesis. At this time, the second mixture was heated at a temperature raising rate of 10° C./min to perform the hydrothermal reaction at a temperature of 150° C. for 10 hours. Thereafter, the solution in which the hydrothermal reaction was completed was cooled to room temperature, and washed with distilled water 5 times at 5,000 rpm using a centrifuge. The washed solution was dried in a vacuum oven maintained at 90° C. for 24 hours to obtain niobium-containing titanium-ruthenium composite nanoparticles.

Thereafter, the niobium-containing titanium-ruthenium composite nanoparticles are heated at a temperature raising rate of 10° C./min and heat-treated at a temperature of 200° C. for 1 hour to finally prepare niobium-containing titanium dioxide (TiO₂)-ruthenium dioxide (RuO₂) composite nanoparticles.

### Example 2

Niobium-containing titanium dioxide (TiO₂)-ruthenium dioxide (RuO₂) composite nanoparticles were prepared in the same manner as in Example 1 except that the content of NbCl₅ contained in the first mixture was adjusted to 5 mol % in Example 1.

### Comparative Example 1 (Titanium Dioxide Nanoparticles)

P25 (Aldrich, purity 99.5%) was prepared as titanium-based nanoparticles (TiO₂), and deionized water prepared using a water purifier (Human Corporation, Human RO 180) was prepared.

A mixture was prepared by adding P25 to deionized water and mixing them for 15 minutes. Thereafter, the mixture was moved to a Teflon container, put in an autocave, and subjected to a hydrothermal reaction in a furnace for hydrothermal synthesis. At this time, the mixture was heated at a temperature raising rate of 10° C./min to perform the hydrothermal reaction at a temperature of 150° C. for 10 hours. Thereafter, the solution in which the hydrothermal reaction was completed was cooled to room temperature, and washed with distilled water 5 times at 5,000 rpm using a centrifuge. The washed solution was dried in a vacuum oven maintained at 90° C. for 24 hours to obtain titanium dioxide (TiO₂) nanoparticles.

### Comparative Example 2 (Excluding Niobium Doping and Heat Treatment Processes)

P25 (Aldrich, purity 99.5%) was prepared as titanium-based nanoparticles (TiO₂), RuCl₃·3H₂O (Aldrich, purity 99.98%) was prepared as a ruthenium precursor, and deionized water prepared using a water purifier (Human Corporation, Human RO 180) was prepared.

P25 was added to deionized water and mixed for 15 minutes, and RuCl₃·3H₂O was added to deionized water mixed with P25 and mixed for an additional 15 minutes to prepare a mixture. At this time, in the mixture, the content of P25 was 94 mol % and the content of RuCl₃·3H₂O was 6 mol % based on a total of 100 mol % of P25 and RuCl₃·3H₂O. Thereafter, the mixture was moved to a Teflon container, put in an autocave, and subjected to a hydrothermal reaction in a furnace for hydrothermal synthesis. At this time, the mixture was heated at a temperature raising rate of 10° C./min to perform the hydrothermal reaction at a temperature of 150° C. for 10 hours. Thereafter, the solution in which the hydrothermal reaction was completed was cooled to room temperature, and washed with distilled water 5 times at 5,000 rpm using a centrifuge. The washed solution was dried in a vacuum oven maintained at 90° C. for 24 hours to obtain titanium dioxide (TiO₂)-ruthenium dioxide (RuO₂) composite nanoparticles.

### Comparative Example 3 (Excluding Niobium Doping Process, Heat Treatment at 200° C.)

The titanium dioxide-ruthenium dioxide composite nanoparticles obtained in Comparative Example 2 above were heated at a temperature raising rate of 10° C./min and thus heat-treated at a temperature of 200° C. for 1 hour to finally prepare titanium dioxide-ruthenium dioxide composite nanoparticles.

### Comparative Example 4 (Excluding Niobium Doping Process, Heat Treatment at 300° C.)

Titanium dioxide-ruthenium dioxide composite nanoparticles were prepared in the same manner as in Comparative Example 2 except that the titanium dioxide-ruthenium dioxide composite nanoparticles were heat-treated at a temperature of 300° C. in Comparative Example 2.

### Comparative Example 5 (Excluding Heat Treatment Process)

Niobium-containing titanium dioxide (TiO₂)-ruthenium dioxide (RuO₂) composite nanoparticles were prepared in the same manner as in Example 1 except that the niobium-containing titanium-ruthenium composite nanoparticles were not heat-treated in Example 1.

### Comparative Example 6 (Heat Treatment at 300° C.)

Niobium-containing titanium dioxide (TiO₂)-ruthenium dioxide (RuO₂) composite nanoparticles were prepared in the same manner as in Example 1 except that the niobium-containing titanium-ruthenium composite nanoparticles were heat-treated at a temperature of 300° C. in Example 1.

### Comparative Example 7 (Titanium Dioxide Nanoparticles, Heat Treatment at 200° C.)

The titanium dioxide nanoparticles prepared in Comparative Example 1 above were heated at a temperature raising rate of 10° C./min and thus heat-treated at a temperature of 200° C. for 1 hour.

### Comparative Example 8 (Adjustment of Content of RuCl₃·3H₂O)

Niobium-containing titanium dioxide (TiO₂)-ruthenium dioxide (RuO₂) composite nanoparticles were prepared in the same manner as in Example 1 except that the content of RuCl₃·3H₂O in the second mixture was adjusted to 12 wt % in Example 1.

### Experimental Example

The physical properties of the prepared nanoparticles were observed and evaluated by using the following experimental equipment.
1. TEM: JEM-2100F, JEOL LTd./acceleration voltage condition of 200 kV
2. Cs-TEM: Cs-corrected monochromated TEM (Themis Z, Thermo Fisher)/acceleration voltage condition of 300 kV
3. XRD: New D8 ADVANCE, Bruker/using Cu Kat radiation (λ=0.1542 nm)
4. XPS: PHI 5000 VersaProbe, ULVAC-PHI/The spectral resolution of the detector is 0.1 eV, the binding energy of the XPS spectrum refers to the C 1s peak located at 284.6 eV
5 Raman: LabRAM HR Evolution, HORIBA
6. Measurement of electrochemical properties:

A solution for deposition was prepared as follows. The composite nanoparticle powders (or nanoparticle powders) prepared in Examples and Comparative Examples above were mixed with 1 mL isopropanol (DAIHAN Scientific), 0.01 mL of Nafion ionomer (Aldrich) was added thereto, and 0.1 mg of Ketjen black powder was added thereto so that a mixed powder solution was prepared. Thereafter, the mixed powder solution was precipitated on an L-type glassy carbon working electrode (WizMAC) through a drop casting process. Through this, a working electrode having an area of 0.5 cm² was prepared.

In order to evaluate the electrocatalytic performance of the composite nanoparticles, cyclic voltammetry (CV) was used. Prepared was a three-electrode system consisting of a working electrode prepared using composite nanoparticles as a working electrode as described above, a Pt wire (CE-1, NEO science) as a counter electrode, and an Ag/AgCl electrode (MF-2052, BASi) as a reference electrode. CV evaluation was performed at a scan rate of 10 mVs⁻¹ at 0.4 V to 1.5 V for Ag/AgCl in 0.6 M NaCl (pH=6). Also, the current density was normalized to an area of 0.5 cm². The potential was adjusted with respect to the Ag/AgCl electrode using a potential difference (model: PARSTAT MC, Princeton Applied Research, USA), and IR correction was performed after electrochemical measurements.

Mott-Schottky plots were obtained over a potential range of −1 V to 1 V in a state in which the frequency is fixed at a fixed frequency of 1,000 Hz in 0.5 M H₂SO₄. In addition, the electrochemically active surface area (ECSA) was determined by the CV within a non-faradaic potential range from −0.3 V to 1 V of different scan rates for Ag/AgCl in 0.6 M NaCl.

A potentiostat was used for all electrochemical measurements. Faradaic efficiency for generating active chlorine was measured by a N-diethyl-p-phenylenediamine (DPD) colorimetric method using a pocket colorimeter II (Hach).

When a constant current was applied for 3 minutes, active chlorine species (HClO, ClO⁻) were generated in the electrolyte, and diluted 10 times with deionized water. Then, as a reagent (Cat. 2105669-KR, Hach) reacting to active chlorine species was added, the color of the electrolyte changed to transparent pink. Since the pH of 0.6 M NaCl is almost neutral, the conversion of HClO and ClO⁻ from Cl₂ gas proceeded simultaneously while applying the current. Finally, according to the DPD colorimetric method, the CER efficiency of the working electrode was calculated as the difference in absorbance of the electrolyte.

Normalized current densities by ECSA and Ru mass were obtained using current densities at potentials 10 mV higher than the thermodynamic potential. Current density normalized to ECSA was obtained through ECSA calculated based on Cdl, and Ru mass for current density normalization was obtained through inductively coupled plasma mass spectrometry (ICP-MS).

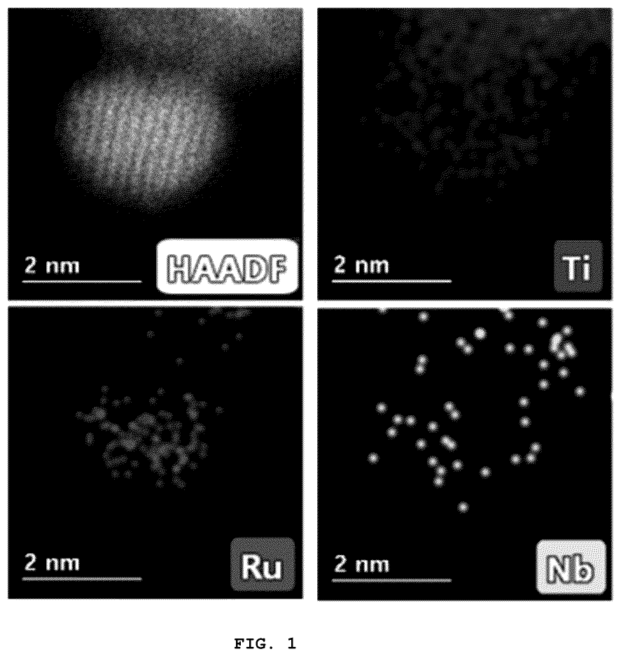

FIG. 1 is a view showing elemental mapping images of niobium-containing titanium-ruthenium composite nanoparticles prepared in Example 1 of the present disclosure. Specifically, FIG. 1 shows elemental mapping images of niobium-containing titanium dioxide-ruthenium dioxide composite nanoparticles prepared in Example 1 through HAADF-STEM EDS analysis using Cs-corrected TEM.

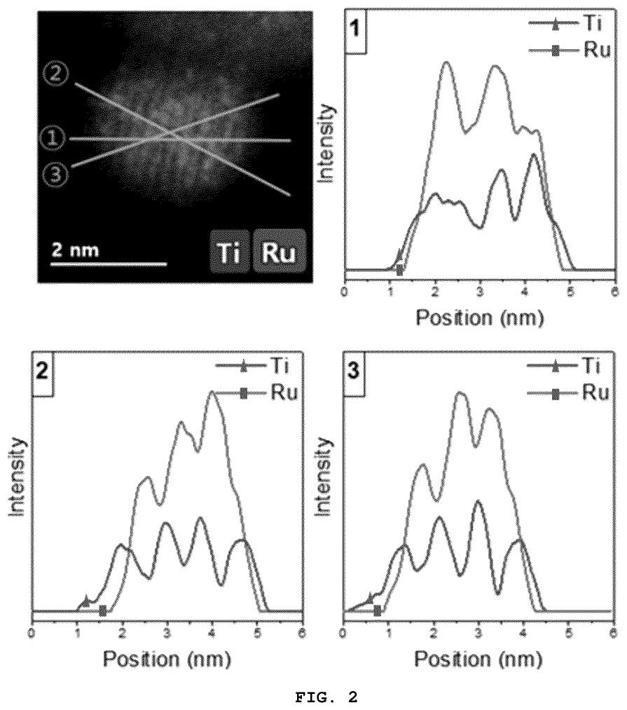

FIG. 2 is a view showing line scan profiles of the niobium-containing titanium-ruthenium composite nanoparticles prepared in Example 1 of the present disclosure.

Referring to FIGS. 1 and 2, it was confirmed that the titanium element and the niobium element were evenly distributed on the surface of the ruthenium dioxide nanoparticles. That is, in the niobium-containing titanium dioxide-ruthenium dioxide composite nanoparticles prepared in Example 1, it can be seen that the niobium-doped titanium dioxide nanoparticles are evenly distributed on the surface of the ruthenium dioxide nanoparticles. In addition, it can be confirmed that the composite nanoparticles in Example 1 have a core-shell structure including a core containing ruthenium-based nanoparticles and a shell containing niobium-doped titanium-based nanoparticles. In addition, it can be seen that the niobium-containing titanium-ruthenium composite nanoparticles prepared in Example 1 have a particle size of 1 nm or more and 2.5 nm or less. In addition, it can be confirmed that titanium is contained in the core of the niobium-containing titanium-ruthenium composite nanoparticles prepared in Example 1.

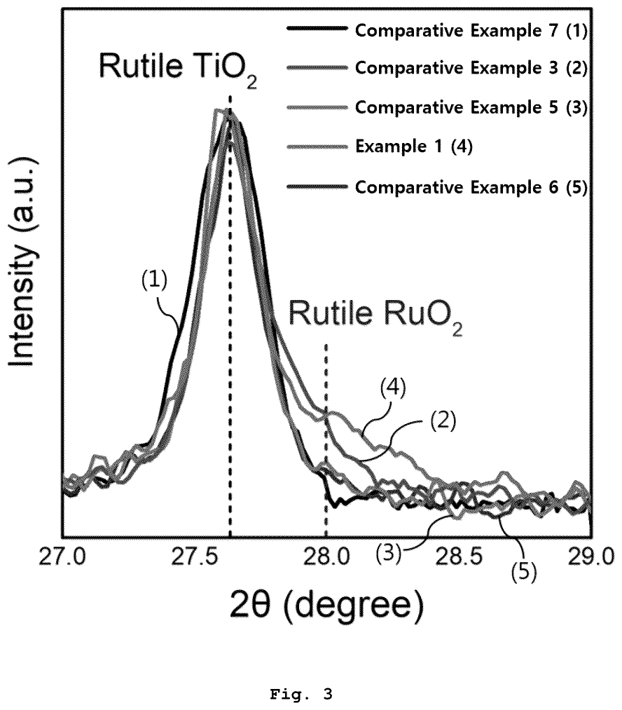

FIG. 3 is a view showing XRD patterns of composite nanoparticles prepared in Example 1, Comparative Example 3, Comparative Example 5, Comparative Example 6, and Comparative Example 7 of the present disclosure. Referring to FIG. 3, it was confirmed that (110) diffraction of ruthenium dioxide having a rutile crystal structure was shown only in the case of Example 1 and Comparative Example 3 in which the prepared composite nanoparticles were subjected to heat treatment at 200° C., and (110) diffraction of ruthenium dioxide was not shown in the case of Comparative Example 5 in which the heat treatment was not performed and Comparative Example 6 in which heat treatment was performed at 300° C.

Through this, it can be seen that in the niobium-containing titanium dioxide-ruthenium dioxide composite nanoparticles of Example 1 in which the heat treatment temperature was adjusted to 200° C., niobium-doped titanium dioxide nanoparticles were formed on the surface of ruthenium dioxide having a rutile crystal structure. In addition, it was confirmed that the (110) diffraction part of RuO₂ shifted to a significantly higher diffraction angle than the referenced XRD spectrum (JCPDS #40-1290). This means that d-spacing of RuO₂ having a rutile crystal structure is reduced due to thermal atom diffusion of titanium having a much smaller atomic number.

Meanwhile, it can be seen that the niobium-containing titanium dioxide-ruthenium dioxide composite nanoparticles of Comparative Example 6 having a heat treatment temperature of 300° C. have a form in which ruthenium dioxide nanoparticles are diffused in a titanium dioxide matrix. That is, it can be seen that the shape of the composite nanoparticles finally prepared varies depending on the temperature at which the niobium-containing titanium dioxide-ruthenium dioxide composite nanoparticles are heat-treated.

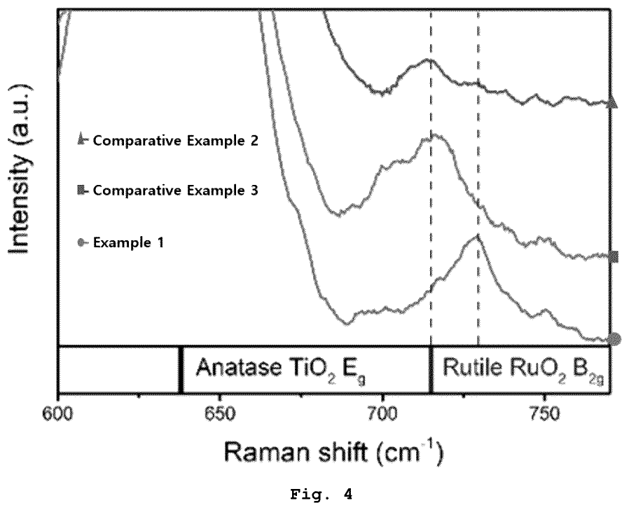

FIG. 4 is a view showing Raman spectra of composite nanoparticles prepared in Example 1, Comparative Example 2, and Comparative Example 3 of the present disclosure.

Referring to FIG. 4, in the case of the niobium-containing titanium dioxide-ruthenium dioxide composite nanoparticles prepared in Example 1, it was confirmed that the Raman scattering of RuO₂ B_{2g} shifts from 716 cm¹ to a higher value of 730 cm¹. This means that the reduced lattice constant caused a compressive strain to generate a blue-shift, thereby reducing the lattice constant of RuO₂.

Through FIGS. 3 and 4, it can be confirmed that the niobium-containing titanium dioxide-ruthenium dioxide composite nanoparticles prepared in Example 1 are a solid solution having a titanium-rich layer in which niobium is doped on the surface of RuO₂ having a rutile crystal structure.

In addition, referring to FIGS. 3 and 4, Comparative Example 3 heat-treated the composite nanoparticles at 200° C., but titanium dioxide was not doped with niobium so that it was confirmed that no peak shift occurred in the XRD pattern and Raman spectrum. This means that diffusion of titanium into the ruthenium dioxide lattice is not sufficient when there is no niobium doping. Through this, it can be seen that niobium doping is an important factor enabling thermal diffusion of titanium at a temperature as low as 200° C.

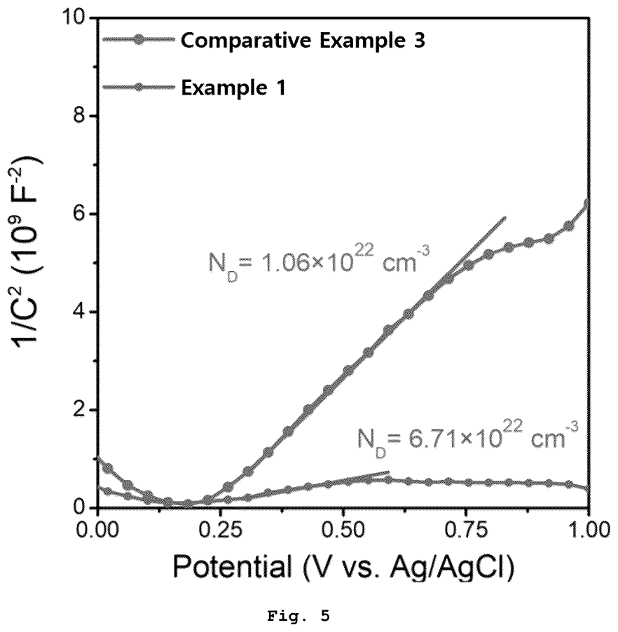

FIG. 5 is a view showing Mott-Schottky measurement results of the composite nanoparticles prepared in Example 1 and Comparative Example 3 of the present disclosure.

Referring to FIG. 5, it was confirmed that a charge carrier concentration of the niobium-containing titanium dioxide-ruthenium dioxide composite nanoparticles of Example 1 in which titanium dioxide was doped with niobium was increased by about 6.3 times compared to Comparative Example 3 without niobium doping. This means that niobium doping can increase the charge carrier concentration, thereby improving electronic conductivity due to more valence electrons. Due to the improved electronic conductivity, it may be predicted that the electron transport from the niobium-containing titanium dioxide-ruthenium dioxide composite nanoparticles to the glassy carbon electrode will be further improved.

X-ray photoelectron spectroscopy (XPS) analysis was performed on the niobium-containing titanium dioxide-ruthenium dioxide composite nanoparticles prepared in Example 1 to measure the numbers of the titanium atoms, ruthenium atoms and niobium atoms contained in the prepared niobium-containing titanium dioxide-ruthenium dioxide composite nanoparticles and show the measured numbers thereof in Table 1 below.

TABLE 1

| | Ti | Ru | Nb |
|---|---|---|---|
| ppb | 6901.2 | 74.4 | 141.7 |
| at % | 96.964 at % | 1.045 at % | 1.991 at % |

Referring to Table 1, it was confirmed that the content of ruthenium atoms was 1.045 at % in the niobium-containing titanium dioxide-ruthenium dioxide composite nanoparticles prepared in Example 1. Accordingly, it can be seen that the content of ruthenium dioxide in the niobium-containing titanium dioxide-ruthenium dioxide composite nanoparticles prepared in Example 1 corresponds to 1.045 at %.

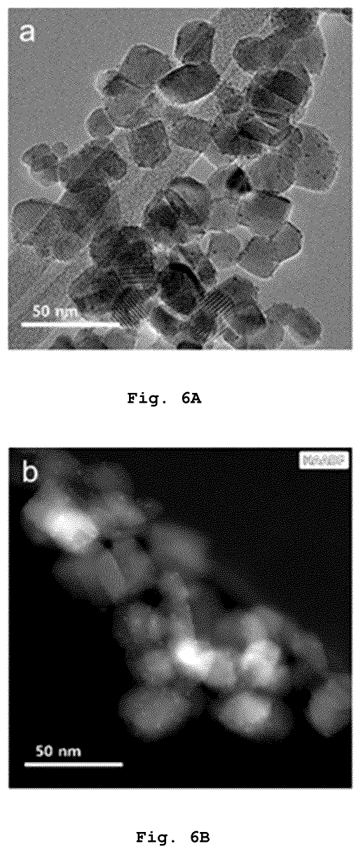

FIGS. 6A to 6D are a view of observing the shape of the composite nanoparticles prepared in Comparative Example 2. Specifically, FIG. 6A is a TEM image of the titanium dioxide-ruthenium dioxide composite nanoparticles prepared in Comparative Example 2, FIG. 6B is a high-angle annular dark-field scanning transmission electron microscopy (HADDF-STEM) image, FIG. 6C is an elemental mapping image, and FIG. 6D is a graph showing the particle size distribution of ruthenium dioxide in the titanium dioxide-ruthenium dioxide composite nanoparticles.

Referring to FIGS. 6A to 6D, in the case of Comparative Example 2, it was confirmed that ruthenium dioxide nanoparticles were grown on titanium dioxide (P25) while being fissioned. Referring to FIGS. 6A and 6D, it was confirmed that RuO₂ nanoparticles with an average size of 1.7 nm, which appear as black dots, were attached to gray TiO₂ nanoparticles with a size of several tens of nanometers. Referring to FIG. 6B, it was confirmed that z-contrast was clearly shown due to the difference in atomic number between Ru and Ti. Referring to FIG. 6C, those appearing as dots are nanoparticles containing Ru, and Ti was detected in larger nanoparticles.

That is, through FIGS. 6A to 6D, since ruthenium dioxide nanoparticles are formed on the surface of the titanium dioxide nanoparticles in the case of the titanium dioxide-ruthenium dioxide composite nanoparticles prepared in Comparative Example 2, it can be seen that the shape of the titanium dioxide-ruthenium dioxide composite nanoparticles prepared in Comparative Example 2 is different from that of the niobium-containing titanium-ruthenium composite nanoparticles prepared in Example 1.

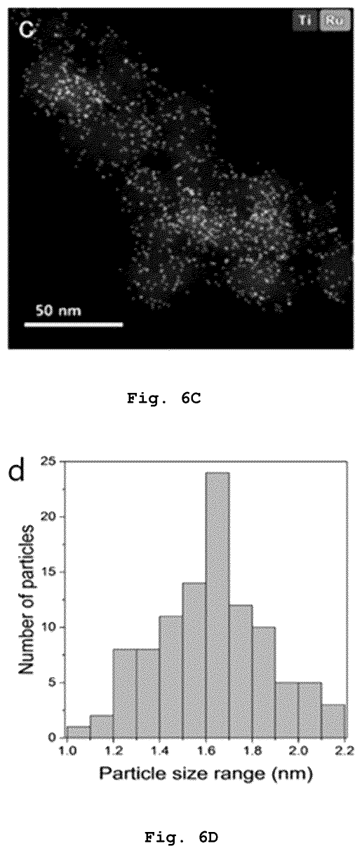

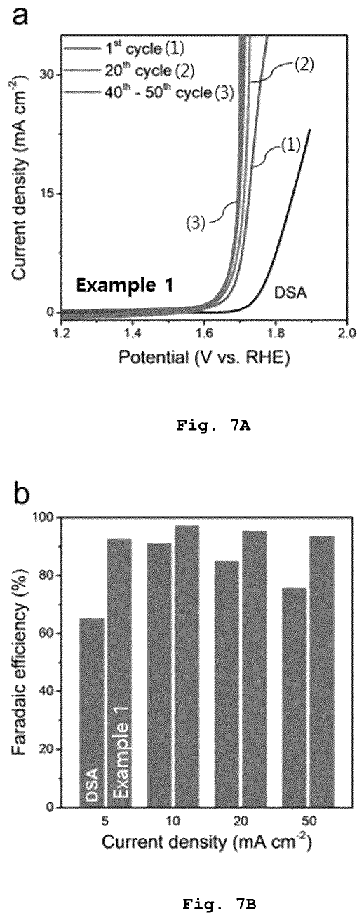

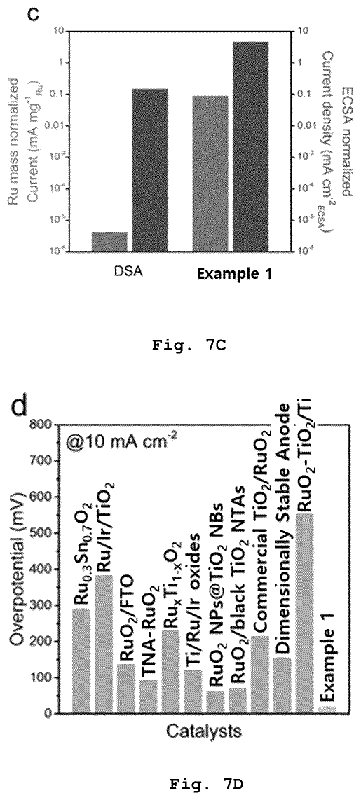

FIGS. 7A to 7D are a view showing results of evaluating the electrochemical properties of the composite nanoparticles prepared in Example 1 of the present disclosure. Specifically, FIG. 7A is a graph showing CV curves of the niobium-containing titanium dioxide-ruthenium dioxide composite nanoparticles prepared in Example 1 and conventional DSA measured at a scan rate of 10 mVs⁻¹ in a 0.6 M NaCl electrolyte. FIG. 7B is a graph showing faradaic efficiencies of the niobium-containing titanium dioxide-ruthenium dioxide composite nanoparticles prepared in Example 1 and conventional DSA at 5, 10, 20, and 50 mA cm². FIG. 7C is a graph showing normalized Ru masses at a current density of 1.323 V for ESCA and NHE of the niobium-containing titanium dioxide-ruthenium dioxide composite nanoparticles prepared in Example 1 and conventional DSA, and FIG. 7D is a graph comparing CER efficiencies of the niobium-containing titanium dioxide-ruthenium dioxide composite nanoparticles prepared in Example 1 and the conventional catalyst. “NHE” means a normal hydrogen electrode, and is a hydrogen electrode when the concentration of H⁺ in the aqueous solution is 1 M and the pressure of hydrogen gas is 1 atm, and the electrode potential at this time is 0 V. More specifically, FIG. 7C shows values obtained by normalizing current density values between Example 1 and DSA electrode using ECSA and Ru mass of Example 1 and DSA, respectively, and normalization was performed on the respective current density values using the current density values at 1.323 V versus NHE.

The electrocatalytic activity and stability of the composite nanoparticles for AC generation were investigated by CV scan at a scan rate of 10 mV s⁻¹ in a 0.6 M NaCl electrolyte at pH 6, and the results are shown in FIG. 7A. Specifically, FIG. 7A shows results obtained after performing the first cycle, the 20th cycle, and the 40th to 50th cycles.

Referring to FIG. 7A, the niobium-containing titanium dioxide-ruthenium dioxide composite nanoparticles prepared in Example 1 were confirmed to maintain a stable electrocatalytic activity until the 50th cycle, and at the same time, have a gradually increased current density as the CV cycle is repeated. Through this, it can be seen that the niobium-containing titanium dioxide-ruthenium dioxide composite nanoparticles prepared in Example 1 have excellent resistance to anodic corrosion.

The potential required to achieve 10 mA cm⁻² was recorded as 1.334 V with respect to NHE. Considering that the equilibrium potential of CER to NHE is 1.313 V, the overpotential of the niobium-containing titanium dioxide-ruthenium dioxide composite nanoparticles prepared in Example 1 is calculated to be 21 mV, which is much lower than commercial DSA (156 mV).

In addition, referring to FIG. 7B and Table 2 below, the niobium-containing titanium dioxide-ruthenium dioxide composite nanoparticles prepared in Example 1 showed improved faradaic efficiency (FE) for AC generation compared to DSA.

TABLE 2

| | FE of DSA | FE of Example 1 |
|---|---|---|
| 5 mA cm⁻² | 65.3% | 62.1% |
| 10 mA cm⁻² | 91.2% | 95.2% |
| 20 mA cm⁻² | 85.1% | 92.2% |
| 50 mA cm⁻² | 75.7% | 90.7% |

Referring to FIG. 7C, it was confirmed that the niobium-containing titanium dioxide-ruthenium dioxide composite nanoparticles prepared in Example 1 showed 1.04 times higher ECSA and 30.4 times higher intrinsic activity compared to DSA. In addition, it was confirmed that the niobium-containing titanium dioxide-ruthenium dioxide composite nanoparticles prepared in Example 1 showed about 20,000 times higher normalized current density for Ru mass compared to DSA.

Referring to FIG. 7D and Table 3 below, it was confirmed that the niobium-containing titanium dioxide-ruthenium dioxide composite nanoparticles prepared in Example 1 had excellent performance compared to known catalysts even in terms of overpotential.

TABLE 3

| | Overpotential | |
|---|---|---|
| | (mV) | Evaluation |
| Material | @10 mV cm⁻² | condition |
| Ru_{0.3}Sn_{0.7}O₂ | 291 | 3.5M NaCl |
| | | pH = 3 |
| Ru/Ir/TiO₂ | 385 | 4.0M NaCl |
| | | pH = 3 |
| RuO₂/FTO | 140 | 5.0M NaCl |
| | | pH = 3.1 |
| TNA—RuO₂ | 100 | 0.1M NaCl |
| | | pH = 6 |
| RuₓTi₁₋ₓO₂ | 231 | 3.5M NaCl |
| | | pH = 3 |
| Ti/Ru/Ir oxides | 125 | 4.0M NaCl |
| | | pH = 3 |
| RuO₂ MPₛ@ | 66 | Saturated NaCl |
| TiO₂ NBₛ | | pH = 3.1 |
| RuO₂/black | 72 | 5.0M NaCl |
| TiO₂ NTAₛ | | pH = 2 |
| Commercial | 216 | Saturated NaCl |
| TiO₂/RuO₂ | | pH = 2 |
| RuO₂ − TiO₂/ | 557 | 0.6M NaCl |
| Ti | | pH = 1.8 |
| Dimensionally | 156 | 0.6M NaCl |
| stable anode | | pH = 6 |
| Example 1 | 21 | 0.6M NaCl |
| | | pH = 6 |
| | 50 | 5.0M NaCl |
| | | pH = 2 |

That is, it can be seen that the niobium-containing titanium-ruthenium composite nanoparticles according to an embodiment of the present disclosure are superior to commercially available catalysts in terms of catalytic activity, product selectivity, and cost efficiency.

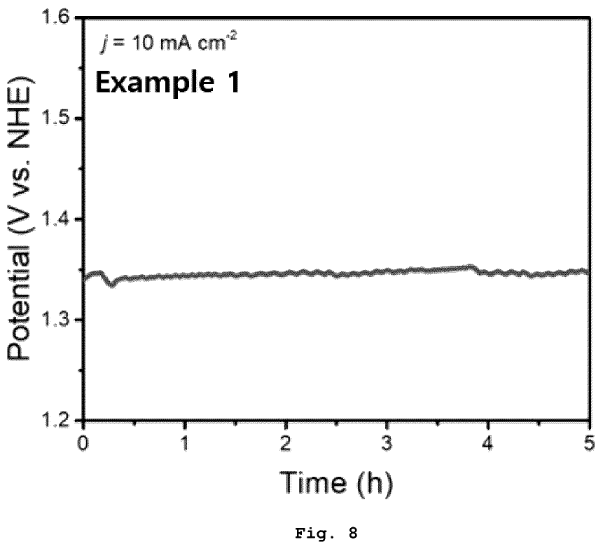

FIG. 8 is a view showing potentials over time recorded during a chronopotentiometric measurement experiment at a current density of 10 mA cm⁻² of the composite nanoparticles prepared in Example 1 of the present disclosure.

Referring to FIG. 8, it can be seen that the potential necessary for the same current density is well maintained in galvanostatic electrolysis similarly to what was confirmed through FIGS. 7A to 7D.

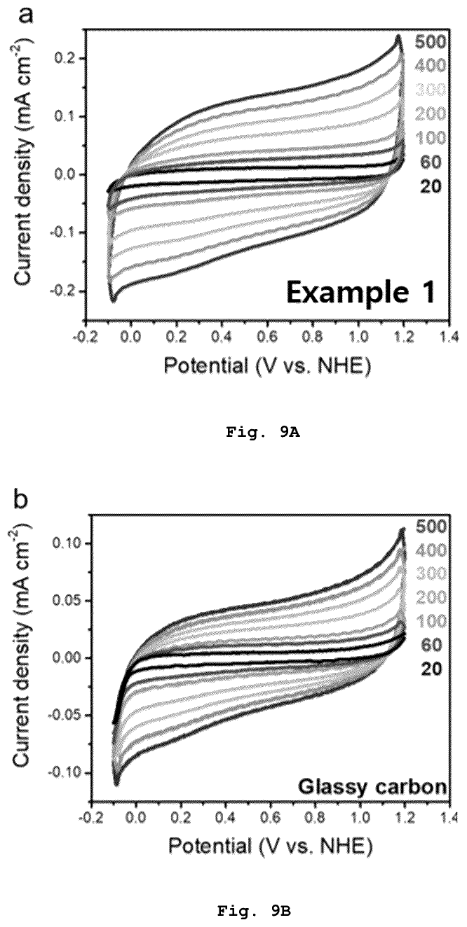

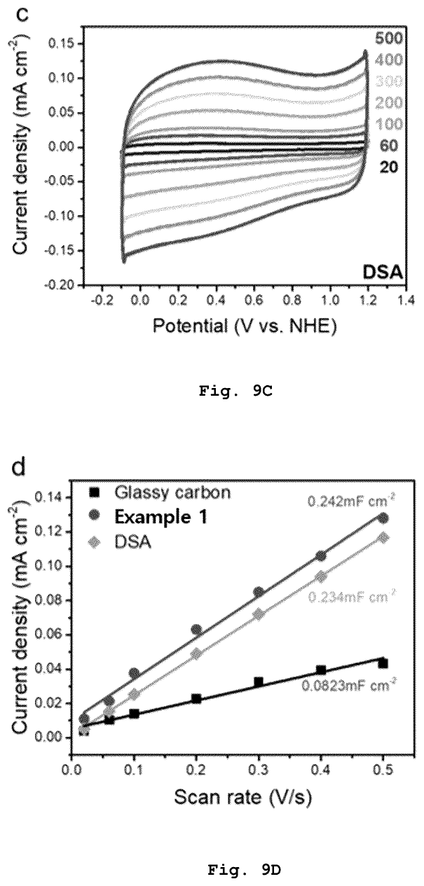

FIGS. 9A to 9D are a view showing CV scan results of the composite nanoparticles prepared in Example 1 of the present disclosure, glassy carbon, and DSAs.

Referring to FIGS. 9A to 9D, it was confirmed that the niobium-containing titanium dioxide-ruthenium dioxide composite nanoparticles prepared in Example 1 had a higher current density than glassy carbon and DSAs.

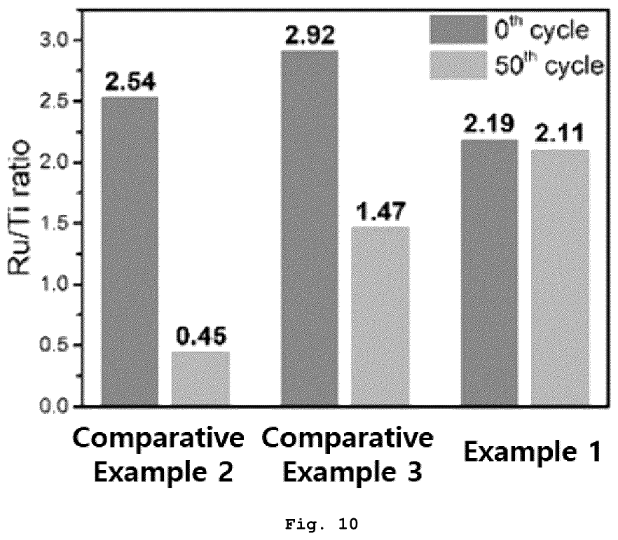

FIG. 10 shows a view showing ratios of Ru/Ti on the surface of the composite nanoparticles before performing CV and after performing 50 CVs for the composite nanoparticles prepared in Example 1, Comparative Example 2, and Comparative Example 3 of the present disclosure. Specifically, FIG. 10 is a graph showing values obtained by calculating the ratios of Ru/Ti on the surface of the composite nanoparticles by performing XPS analysis.

Referring to FIG. 10, it was confirmed that the ratios of Ru/Ti of the niobium-containing titanium dioxide-ruthenium dioxide composite nanoparticles prepared in Example 1 were not significantly decreased even when CV was performed compared to Comparative Examples 2 and 3. It can be seen from this that the niobium-doped titanium dioxide nanoparticles form a layer on the surface of the ruthenium dioxide nanoparticles to improve the durability of RuO₂ against cathodic decomposition.

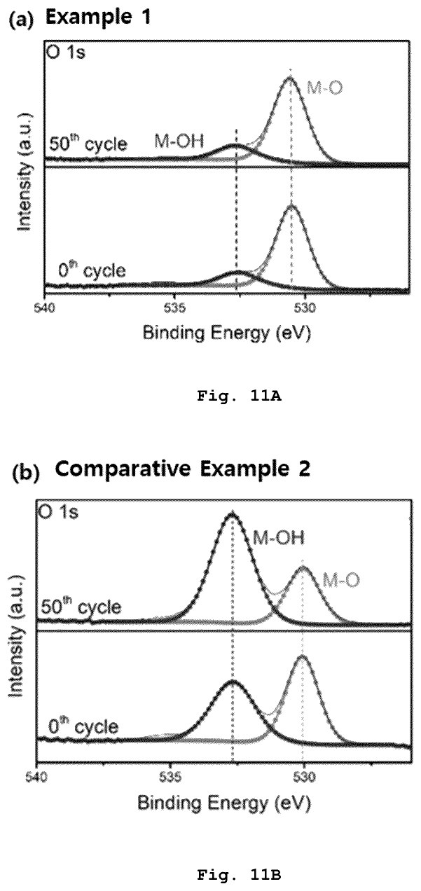

FIGS. 11A to 11C are a view showing XPS spectra of O 1s before performing CV and after performing CV 50 times for the composite nanoparticles prepared in Example 1, Comparative Example 2, and Comparative Example 3 of the present disclosure.

Peaks located at 530.1 and 532.6 eV are reported to be indexed to an M-O bond in the metal oxide bulk lattice and an M-OH bond in the hydrate surface layer (M=Ru or Ti), respectively. Therefore, if the M-OH bond have much higher peak intensities than the M-O bond observed after the 50th cycle of CV, this means that the metal oxides are watered and functionalized by hydroxyl groups.

Referring to FIG. 11A, through the XPS O 1s spectra measured before and after the CV scan, it was confirmed that the intensity ratios of the M-OH bond to the M-O bond were maintained even after applying the anodic potential. Specifically, before performing CV compared to after performing CV 50 times, the niobium-containing titanium-ruthenium composite nanoparticles prepared in Example 1 had a peak intensity retention rate of the M-O bond of 99.62% and a peak intensity of the M-OH bond slightly increased by 0.27%.

Meanwhile, in the case of Comparative Example 2 and Comparative Example 3 in which niobium was not doped on the titanium dioxide nanoparticles, it was confirmed that the peak intensity of the M-OH bond increased than that of the M-O bond in the case of proceeding with the 50th cycle of CV compared to the initial cycle.

Through this, it can be seen that since niobium is doped on the titanium dioxide nanoparticles, not only the electronic conductivity of the niobium-containing titanium-ruthenium composite nanoparticles may be improved, but also the hydroxylation of titanium dioxide may be effectively suppressed.

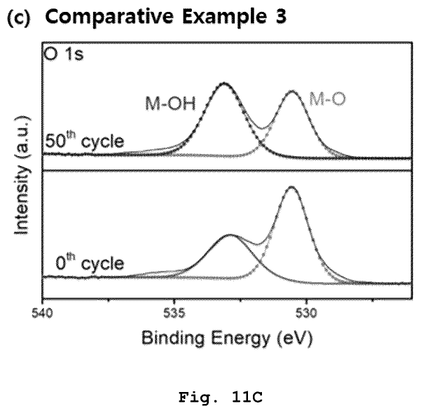

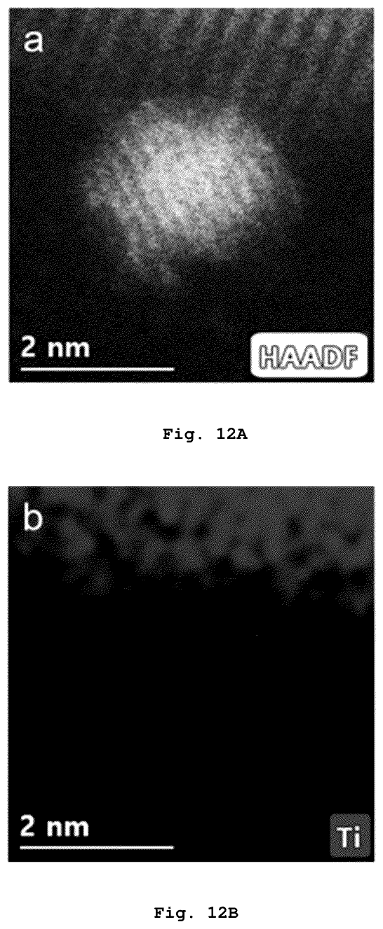

FIGS. 12A to 12C are a view showing elemental mapping images of the composite nanoparticles prepared in Comparative Example 3. Specifically, FIGS. 12A to 12C show elemental mapping images of titanium dioxide-ruthenium dioxide composite nanoparticles prepared in Comparative Example 3 through HAADF-STEM EDS analysis using Cs-corrected TEM.

Referring to FIGS. 12A to 12C, it can be confirmed that the titanium element and the ruthenium element are separately distributed. That is, it can be seen that when titanium dioxide nanoparticles are not doped with niobium, titanium dioxide nanoparticles and ruthenium dioxide nanoparticles are not effectively mixed even when heat treatment is performed under the same conditions.

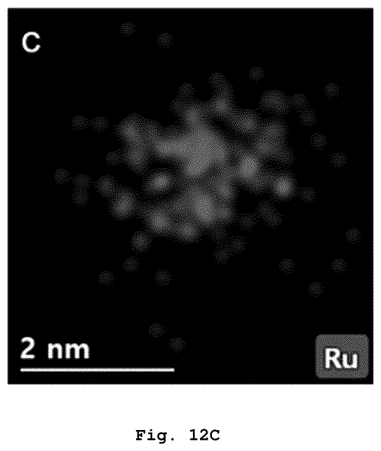

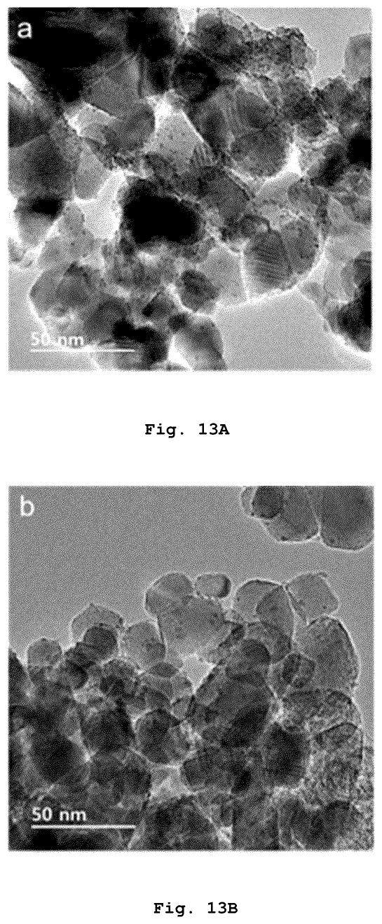

FIGS. 13A to 13C are a view showing transmission electron microscope (TEM) images according to performing a CV cycle of the composite nanoparticles prepared in Comparative Example 4. Specifically, FIG. 13A is a TEM image of titanium dioxide-ruthenium dioxide composite nanoparticles prepared in Comparative Example 4 before performing CV, FIG. 13B is a TEM image after performing 20 cycles of CV, and FIG. 13C is a TEM image after performing 50 cycles of CV.

Referring to FIGS. 13A to 13C, it was confirmed that as the CV cycle was performed, the ruthenium dioxide nanoparticles appearing in dark black gradually disappeared. Through this, it can be seen that when titanium dioxide is not doped with niobium, it is difficult to suppress dissolution of the RuO₂ nanoparticles.

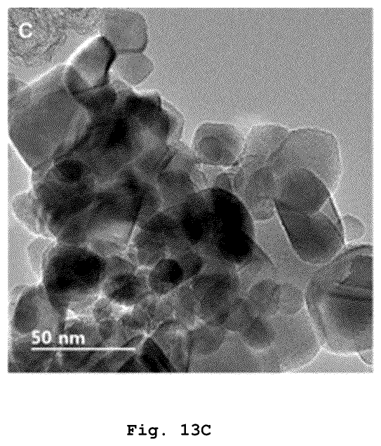

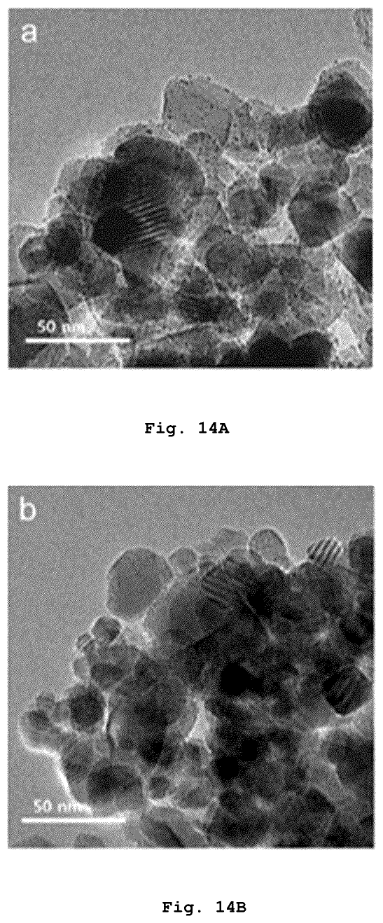

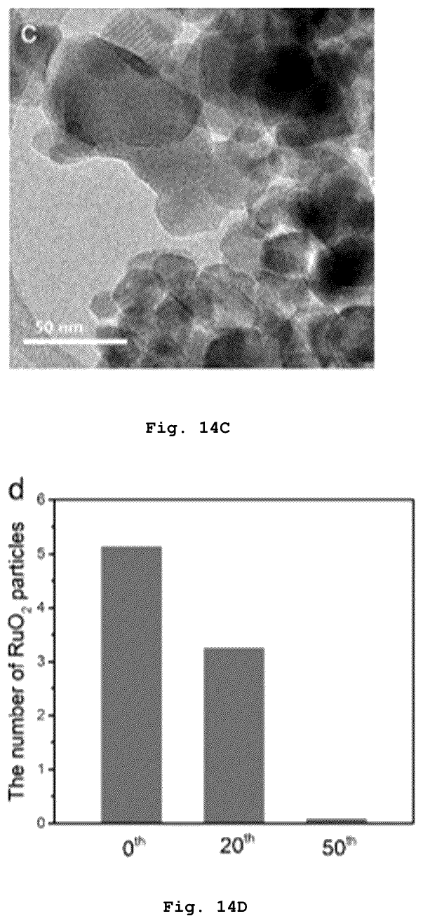

FIGS. 14A to 14D are a view showing results of observing the shape of the composite nanoparticles prepared in Comparative Example 2 according to performing a CV cycle. Specifically, FIG. 14A is a TEM image of titanium dioxide-ruthenium dioxide composite nanoparticles prepared in Comparative Example 2 before performing CV, FIG. 14B is a TEM image after performing 20 cycles of CV, FIG. 14C is a TEM image after performing 50 cycles of CV, and FIG. 14D is a graph showing the numbers of RuO₂ particles per an area of 100 nm² of composite nanoparticles according to the number of CV cycles.

Referring to FIGS. 14A to 14D, as the CV cycle was performed similarly to FIGS. 13A to 13C, it was confirmed that ruthenium dioxide nanoparticles showing a dark black color gradually disappeared. Through this, it can be seen that when titanium dioxide is not doped with niobium, it is difficult to suppress dissolution of the RuO₂ nanoparticles.

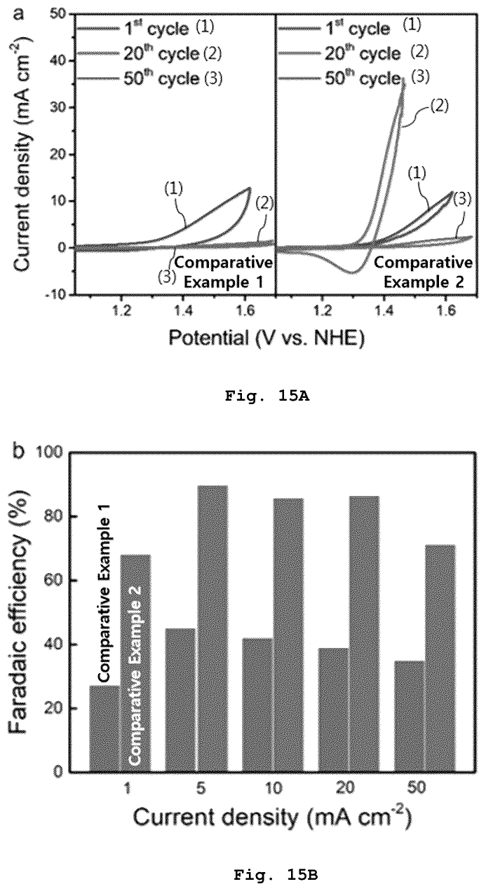

FIGS. 15A and 15B are a view showing evaluation of the electrochemical properties of the composite nanoparticles prepared in Comparative Example 1 and the composite nanoparticles prepared in Comparative Example 2. For the titanium dioxide nanoparticles prepared in Comparative Example 1 and the titanium dioxide-ruthenium dioxide composite nanoparticles prepared in Comparative Example 2, CV was performed at a scan rate of 10 mV s⁻¹ in a 0.6 M NaCl electrolyte of pH 6. The CV scan was repeated for 50 cycles in order to observe a trend of current density to cycle number, and the results are shown in FIG. 15A.

Referring to FIG. 15A, the titanium dioxide nanoparticles of Comparative Example 1 had a continuously decreased oxidation current during the CV scan, and thus finally showed an almost flat current. Meanwhile, while the oxidation current of the titanium dioxide-ruthenium dioxide composite nanoparticles of Comparative Example 2 increased step by step until the 20th cycle, the current decreased close to 0 thereafter. This shows completely different results from Example 1 shown in FIG. 7A.

Referring to FIG. 15B, it was confirmed that the titanium dioxide-ruthenium dioxide composite nanoparticles of Comparative Example 2 were excellent in faradaic efficiency compared to the titanium dioxide nanoparticles of Comparative Example 1. Through this, it can be seen that the titanium dioxide-ruthenium dioxide composite nanoparticles have improved catalytic properties compared to the titanium dioxide nanoparticles alone by including the ruthenium dioxide nanoparticles.

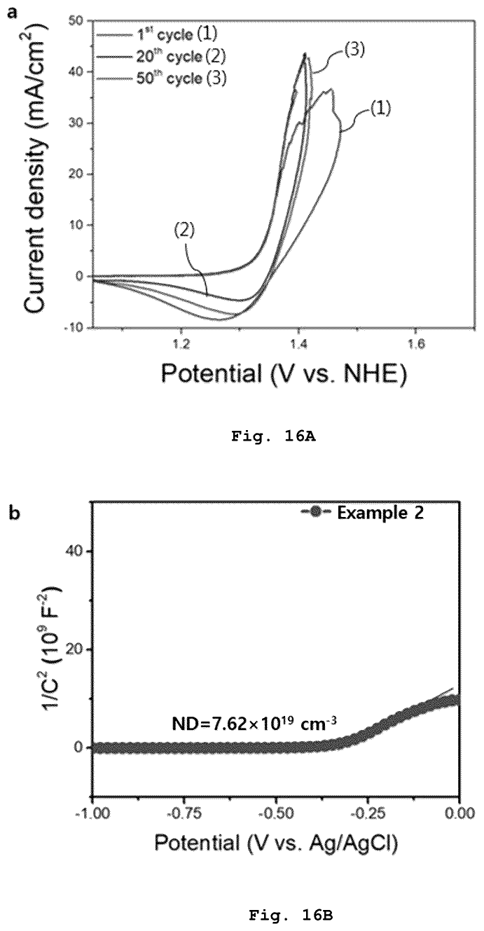

FIGS. 16A and 16B are a view showing results of evaluating the electrochemical properties of the composite nanoparticles prepared in Example 2 of the present disclosure. Specifically, FIG. 16A is a view showing CV curves according to the number of CV cycles at a scan rate of 10 mVs⁻¹ in a 0.6 M NaCl electrolyte, and FIG. 16B is a view showing Mott-Schottky measurement results of the composite nanoparticles prepared in Example 2.

Referring to FIGS. 5, 7, and 16, it was confirmed that the niobium-containing titanium dioxide-ruthenium dioxide composite nanoparticles prepared in Example 1 had superior excellent catalytic properties compared with the niobium-containing titanium dioxide-ruthenium dioxide composite nanoparticles prepared in Example 2. Specifically, when the potential is read based on a specific current density on the CV graph, it is evaluated that the lower the potential, the more excellent the catalytic properties. In this regard, Example 2 (proceeding 5% by mol of Nb doping) showed a higher potential than Example 1 (proceeding 1% by mol of Nb doping), showed inferior catalytic properties compared to Example 1, and also showed a lower charge concentration than Example 1 even in the Mott-Schottky characteristic evaluation in which the charge concentration was calculated.

FIG. 17 is a view comparing electrochemical property evaluation results of composite nanoparticles prepared in Example 1 and Comparative Example 8 of the present disclosure. Specifically, FIG. 17 is a graph showing CV curves of niobium-containing titanium dioxide-ruthenium dioxide composite nanoparticles prepared in Example 1 and Comparative Example 8 and conventional DSA measured at a scan rate of 10 mV s⁻¹ in a 0.6 M NaCl electrolyte. Referring to FIG. 17, it was confirmed that the niobium-containing titanium dioxide-ruthenium dioxide composite nanoparticles prepared in Comparative Example 8 exhibited a lower current density than the niobium-containing titanium dioxide-ruthenium dioxide composite nanoparticles of Example 1.

The foregoing detailed description is intended to illustrate and explain the present disclosure. In addition, the foregoing contents merely represent and describe the preferred embodiments of the present disclosure, and as described above, the present disclosure can be used in various other combinations, changes and environments, and changes or modifications are possible within the scope of the concept of the invention disclosed in this specification, the scope equivalent to the written disclosure and/or the scope of skill or knowledge in the art. Accordingly, the detailed description of the invention described above is not intended to limit the present disclosure to the disclosed embodiments. Also, the appended claims should be construed to cover other embodiments as well.

1. A method for preparing niobium-containing titanium-ruthenium composite nanoparticles, the method comprising the steps of:
preparing niobium-doped titanium-based nanoparticles by performing hydrothermal reaction of a first mixture containing a niobium precursor and titanium-based nanoparticles;
preparing niobium-containing titanium-ruthenium composite nanoparticles by performing hydrothermal reaction of a second mixture containing the niobium-doped titanium-based nanoparticles and a ruthenium precursor; and
heat-treating the niobium-containing titanium-ruthenium composite nanoparticles.

2. The method of claim 1, wherein the first mixture contains the niobium precursor in an amount of 0.5 mol % or more and 7 mol % or less.

3. The method of claim 1, wherein the titanium-based nanoparticles include titanium dioxide (TiO2) nanoparticles.

4. The method of claim 1, wherein the hydrothermal reaction of the first mixture is performed at a temperature of 150° C. or higher and 200° C. or lower for a time of 5 hours or more and 8 hours or less.

5. The method of claim 1, wherein the ruthenium precursor is contained in the second mixture in an amount of 3 wt % or more and 10 wt % or less.

6. The method of claim 1, wherein the hydrothermal reaction of the second mixture is performed at a temperature of 130° C. or higher and 180° C. or lower for a time of 8 hours or more and 15 hours or less.

7. The method of claim 1, wherein the heat treatment is performed at a temperature of 150° C. or higher and 250° C. or lower.

8. The method of claim 1, wherein the niobium-containing titanium-ruthenium composite nanoparticles are niobium-containing titanium dioxide (TiO2)-ruthenium dioxide (RuO2) composite nanoparticles.

9. Niobium-containing titanium-ruthenium composite nanoparticles comprising:
a core containing ruthenium-based nanoparticles; and
a shell which is provided on the surface of the core and contains niobium-doped titanium-based nanoparticles.

10. The niobium-containing titanium-ruthenium composite nanoparticles of claim 9, wherein the core further contains titanium.

11. The niobium-containing titanium-ruthenium composite nanoparticles of claim 9, wherein the shell is a single layer, and the shell has a thickness of 3 Å or more and 10 Å or less.

12. The niobium-containing titanium-ruthenium composite nanoparticles of claim 9, wherein the niobium-containing titanium-ruthenium composite nanoparticles have an average particle size of 1 nm or more and 2.5 nm or less.

13. The niobium-containing titanium-ruthenium composite nanoparticles of claim 9, wherein the titanium-based nanoparticles are titanium dioxide (TiO2) nanoparticles, and the ruthenium-based nanoparticles are ruthenium dioxide (RuO2) nanoparticles.

14. The niobium-containing titanium-ruthenium composite nanoparticles of claim 9, wherein the ruthenium-based nanoparticles are contained in an amount of 2 at % or less.

15. The niobium-containing titanium-ruthenium composite nanoparticles of claim 9, wherein the content of niobium is 1.5 at % or more and 5 at % or less.

16. The niobium-containing titanium-ruthenium composite nanoparticles of claim 9, wherein the titanium-based nanoparticles have an anatase crystal structure, and the ruthenium-based nanoparticles have a rutile crystal structure.

17. The niobium-containing titanium-ruthenium composite nanoparticles of claim 9, wherein a Raman peak is shifted upward compared to that of ruthenium dioxide, and the upward shift is shifted upward at a wave number of 720 cm-1 or more and 740 cm-1 or less.

18. The niobium-containing titanium-ruthenium composite nanoparticles of claim 9, wherein the niobium-containing titanium-ruthenium composite nanoparticles have a faradaic efficiency of 90% or more at a current density of 5 mA cm-2 or more and 50 mA cm-2 or less.

19. The niobium-containing titanium-ruthenium composite nanoparticles of claim 9, wherein the niobium-containing titanium-ruthenium composite nanoparticles have an overpotential value of 15 mV or more and 60 mV or less under conditions of 0.5 M or more and 5.5 M or less NaCl, pH 2 or more and 6 or less, and 10 mV cm-2.

20. A chlorine evolution electrode comprising the niobium-containing titanium-ruthenium composite nanoparticles according to claim 9.
